(19) United States
(12) Patent Application Publication
(10) Pub. No.: US 2014/0022402 A1
(43) Pub. Date: Jan. 23, 2014

(54) METHOD AND APPARATUS FOR AUTOMATIC CAPTURE OF MULTIMEDIA INFORMATION

(71) Applicants: Pranav Mishra, Bangalore (IN); Rajeswari Kannan, Bangalore (IN)

(72) Inventors: Pranav Mishra, Bangalore (IN); Rajeswari Kannan, Bangalore (IN)

(73) Assignee: NOKIA CORPORATION, Espoo (FI)

(21) Appl. No.: 13/945,912

(22) Filed: Jul. 19, 2013

(30) Foreign Application Priority Data
Jul. 23, 2012 (IN) 3006/CHE/2012

(51) Int. Cl. H04N 5/232; H04N 7/18; G06F 3/00

(52) U.S. Cl. CPC H04N 5/23222; G06F 3/005; H04N 7/181
USPC 348/207.11; 348/211.11

(57) ABSTRACT

A method, apparatus and computer program product of using one or more multi-media recording devices to capture audio/video records of scenes and events remotely and automatically through a recording interface. A configuration server acting as a recording interface receives conditional configuration settings from a user. Through a control function, the configuration server interface configures one or more remote media devices such as video cameras or audio recording equipment to capture a designated scene or event. If more than one device may be necessary to perform the scene capture, the interface may send assistance requests to additional media devices to acquire necessary scene coverage. The interface monitors the scene capture as it occurs and directs the multimedia data to streaming or storage as the initial configuration settings require.

### TECHNOLOGICAL FIELD

The embodiments disclosed herein relate to the field of multimedia information acquisition and recording, specifically the automatic recording of video, image, and voice through portable video, camera and microphones by configuring computer-based applications for the purpose.

### BACKGROUND

Evolving technology is making the recording of images, video, and sound in all sorts of environments easier. There are devices in the market today that can record video data, make sound recordings and take still camera images in almost any location at the touch of a button. Anyone with a personal digital assistant, a cell phone, or other computing device equipped with a camera is carrying his/her own small multimedia production unit with them.

A next phase of the development of portable, convenient multimedia recording capability is automation. It should be possible to program some recording tasks, not only on the equipment itself, but remotely through an interface that communicates between a base station such as a home or office computer, and the remote recording device. By accessing a software application that can communicate through such an interface it should be possible to program and execute the automatic recording of multimedia data by the sound and video equipment “in the field”.

### BRIEF SUMMARY

In a first embodiment, a method is provided comprising receiving configuration settings including a scene target for media capture, analyzing a camera scene to determine if the scene target is in view; receiving recorded scene data of the scene that has been captured according to the configuration settings; and causing the recorded scene data to be sent to data storage. The method may also comprise causing an inability to execute configuration to be reported in the instance that the scene target is not in view. The method may include streaming the scene media data for immediate viewing.

Another method embodiment comprises receiving conditional configuration data including scene target for media capture, configuring one or more camera devices, monitoring media captures by the one or more configured devices, and directing streamed output or storage of captured media data. This method may further comprise causing one or more requests for assistance to accomplish media capture to be sent, configuring one or more assisting camera devices to accomplish media capture, and/or starting a scene capture based on a biofeedback indicator. The biofeedback indicators may include at least one of: happiness, anger, sight focus, a handclap, a gesture, closed eyes, and speech patterns. The one or more camera devices may be disposed in eyeglasses. The method may also comprise receiving the conditional configuration from a calendar software application. A signal to begin media capture may originate in the calendar software application and a signal to terminate media capture may originate in the calendar software application. Such a signal could also be caused by gestures that signal start recording, pause, resume, or stop. The method may also include actuating one or more secondary cameras to record a target scene when the primary camera is unable to record the target scene, conditioning audio/video capture on the presence of a specified individual in a scene, and/or conditioning audio/video capture on the occurrence of a specified event.

Another embodiment is provided wherein an apparatus may comprise at least a processor, a memory associated with the processor, and computer coded instructions stored in the memory, the instructions, when executed by the processor, causing the apparatus to receive configuration settings including a scene target for media capture, analyze a camera scene to determine if the scene target is in view, receive recorded scene data of the scene that has been captured according to the configuration settings, and cause recorded scene data to be sent to data storage. The apparatus may also cause an inability to execute the configuration to be reported in the instance that the scene target is not in view. The apparatus may also be configured to stream the scene media data for immediate viewing.

In another embodiment the apparatus may comprise at least a processor, a memory associated with the processor, and computer coded instructions stored in the memory, the instructions, when executed by the processor, causing the apparatus to receive conditional configuration data including scene target for media capture, configure one or more camera devices, monitor media captures by the one or more configured devices, and direct streamed output or storage of captured media data. The instructions may also cause the apparatus to cause one or more requests for assistance to accomplish media capture to be sent, configure one or more assisting camera devices to accomplish media capture, and/or start a scene capture based on a biofeedback indicator. The biofeedback indicator may include at least one of happiness, anger, sight focus, a handclap, a gesture, closed eyes, and speech patterns. Sensors in the wearable recording device worn by the user sense these biofeedback patterns. The one or more camera devices may be disposed in eyeglasses. The computer instructions may further cause the apparatus to receive the conditional configuration from a calendar software application. A signal to begin media capture may originate in the calendar software application, and a signal to terminate media capture may also originate in the calendar software application. The instructions executed in the processor may further cause the apparatus to actuate one or more secondary cameras to record a target scene when the primary camera is unable to record the target scene, condition audio/video capture on the presence of a specified individual in a scene, or condition audio/video capture on the occurrence of a specified event.

Another embodiment provides an apparatus comprising a means for receiving configuration settings including a scene target for media capture, means for analyzing a camera scene to determine if the scene target is in view, means for receiving recorded scene data of the scene that has been captured according to the configuration settings; and means for causing the recorded scene data to be sent to data storage. This apparatus may further comprise means for causing an inability to execute the configuration to be reported in the instance that the scene target is not in view. The apparatus may further include means for streaming the scene media data for immediate viewing.

Another apparatus is provided with means for receiving conditional configuration data including scene target for media capture, means for configuring one or more camera devices, means for monitoring media captures by the one or more configured devices, and means for directing streamed output or storage of captured media data. The apparatus may also include means for causing one or more requests for assistance to accomplish media capture to be sent, means for configuring one or more assisting camera devices to accomplish media capture, and/or means for starting a scene capture based on a biofeedback indicator. The biofeedback indicators may include at least one of: happiness, anger, sight focus, a handclap, a gesture, closed eyes, and speech patterns. The one or more camera devices may be disposed in eyeglasses. The apparatus may comprise means for receiving the conditional configuration from a calendar software application, and a signal to begin media capture originates in the calendar software application, while a signal to terminate media capture originates in the calendar software application. The apparatus may further include means for actuating one or more secondary cameras to record a target scene when the primary camera is unable to record the target scene, means for conditioning audio/video capture on the presence of a specified individual in a scene, and/or means for conditioning audio/video capture on the occurrence of a specified event.

Yet another embodiment may be a computer program product comprising a computer readable medium having coded computer instructions stored therein, said instructions when executed by a processor causing a device to perform receiving configuration settings including a scene target for media capture, analyzing a camera scene to determine if the scene target is in view, receiving recorded scene data of the scene that has been captured according to the configuration settings, and causing recorded scene data to be sent to data storage. The product may include instructions for causing an inability to execute configuration to be reported in the instance that the scene target is not in view. The product may include instructions for streaming the scene media data for immediate viewing.

In another embodiment, a computer program product may comprise a computer readable medium having coded computer instructions stored therein, said instructions when executed by a processor causing a device to perform, receiving conditional configuration data including scene target for media capture, configuring one or more camera devices, monitoring media captures by the one or more configured devices, and directing streamed output or storage of captured media data. The instructions may further cause a device to perform causing one or more requests for assistance to accomplish media capture to be sent, configuring one or more assisting camera devices to accomplish media capture, and/or starting a scene capture based on a biofeedback indicator. The biofeedback indicators may include at least one of: happiness, anger, sight focus, a handclap, a gesture, closed eyes, and speech patterns. The one or more camera devices may be disposed in eyeglasses. The instructions may further cause the product to perform receiving the conditional configuration from a calendar software application, wherein a signal to begin media capture originates in the calendar software application and a signal to terminate media capture originates in the calendar software application. The computer program product may cause a device to perform actuating one or more secondary cameras to record a target scene when the primary camera is unable to record the target scene, conditioning audio/video capture on the presence of a specified individual in a scene, or conditioning audio/video capture on the occurrence of a specified event.

### BRIEF DESCRIPTION OF THE SEVERAL VIEWS OF THE DRAWINGS

Having thus described certain embodiments of the invention in general terms, reference will now be made to the accompanying drawings, which are not necessarily drawn to scale, and wherein:

FIG. 1a is a block diagram of a system that may support an example embodiment of the present invention;

FIG. 1b is a block diagram of an apparatus that may be specifically configured in accordance with an example embodiment of the present invention;

FIG. 2 is a schematic diagram of a remote audio/video recording platform;

FIG. 3 is a schematic diagram of an embodiment of a remote camera control configuration;

FIG. 4 is a flow diagram of a process by which target media events may be captured in accordance with an example embodiment of the present invention; and

FIG. 5 is a flow diagram of a control process of a media capture system in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

An embodiment for automating the capture of multimedia data by remote media devices includes the recording devices, a software interface between a host computing device and the media devices, and the method by which they interact to automatically record and upload multimedia information. Devices that can be included in the embodiments described here can range from mobile computing devices (e.g., laptops, notebooks, readers and the like) to more personal and easily portable communication devices (e.g., cell phones, music or game players, smartphones and the like) that include cameras and microphones. They may also include devices such as wearable eyeglasses equipped with a miniature digital camera and microphone.

An interface to link a central computing device to the remote multimedia recording devices can be implemented by a calendar software application modified to send commands over wireless links to the recording devices. The calendar application can specify a date/time during which the capture takes place, adapting its existing capability to track date and time and to present notices when events are to occur. With more sophisticated modification, the interface can provide several more capabilities.

The interface could be programmed to send visual cues to the recording device for activating a video capture session. Audio cues can be programmed and delivered to the recording device such that the mention of a particular word or phrase, or the identity of a speaker, causes audio or audio/visual recording to be initiated. The identity of other devices or other users with their own devices who can be enlisted to help record target events can be identified to the interface for inclusion in a recording event.

The recording devices can be set to record based on biofeedback indicators from the user. For instance, an emotional indicator from the user, such as happiness or anger, could trigger recording. Recording can be initiated by a clap from the user, or a gesture before the camera, or a key word spoken into the microphone. Audio/video capture can be configured to begin if the user, witness to an event of interest (e.g., a cricket match, a meeting, etc.) falls asleep. Recording saves the event and when the user awakes, it is available for viewing.

Recording by other users can be arranged and directed to the first user. The interface can be configured such that secondary users can be identified to record an event. An internet protocol (IP) or other address can be provided to the secondary users for either uploading the recording or for streaming the recorded data in real time. Alternatively, the recorded data could be posted to the target IP address periodically during the event. The secondary user's recording can act as a backup to the primary user in the event that the primary user is distracted from the event and turns away. A real-time stream from the secondary user can fill in the sights and sounds of the event even though the primary user's attention is elsewhere at that moment.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

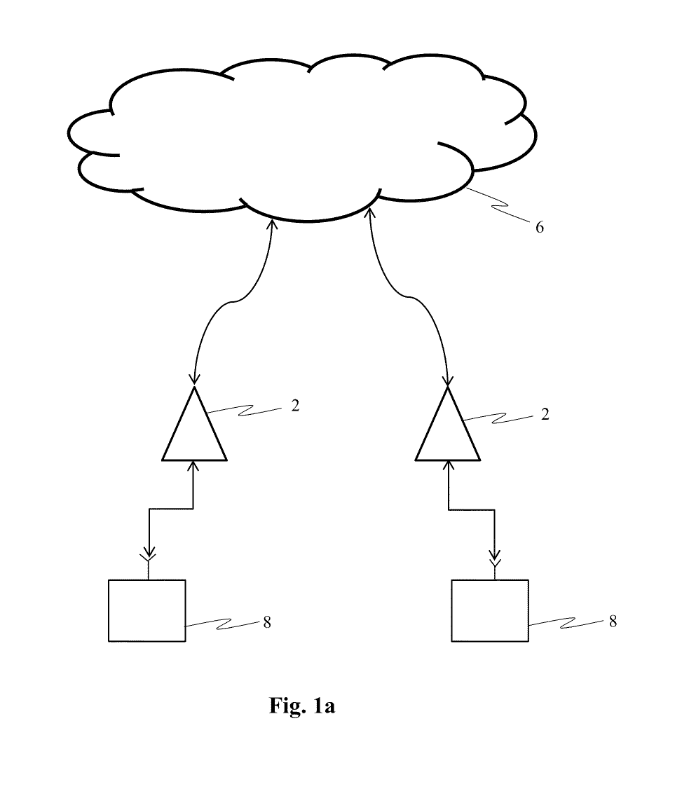

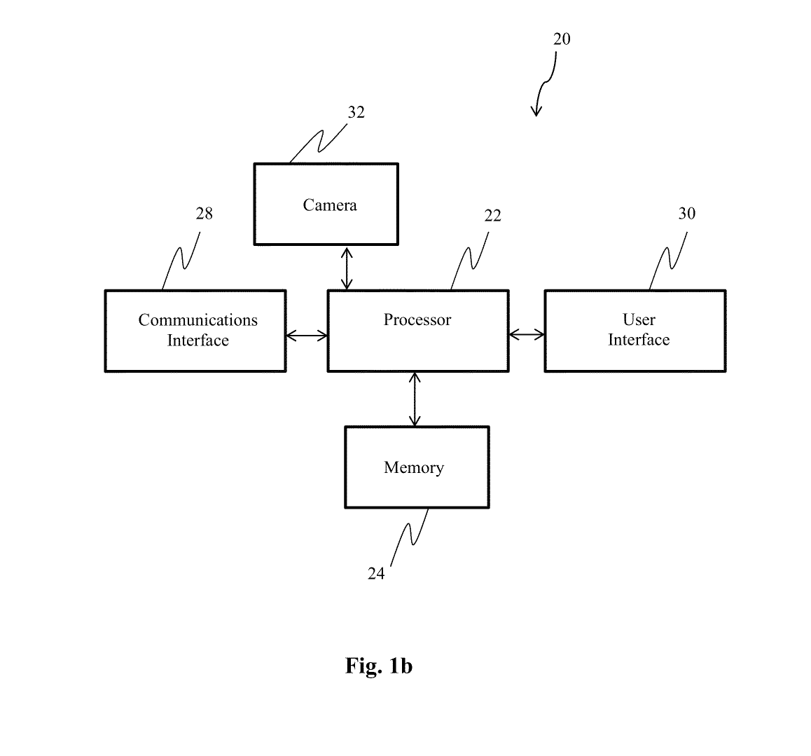

Although the method, apparatus and computer program product of example embodiments of the present invention may be implemented in a variety of different systems, one example of such a system is shown in FIG. 1a, which includes a mobile terminal 8 that is capable of communication with a network 6 (e.g., a core network) via, for example, a radio network controller (RNC) 2. While the network may be configured in accordance with a Universal Mobile Telecommunications System (UMTS) Terrestrial Radio Access Network (UTRAN), the network may employ other mobile access mechanisms such as Long Term Evolution (LTE), LTE-Advanced (LTE-A), wideband code division multiple access (W-CDMA), CDMA2000, global system for mobile communications (GSM), general packet radio service (GPRS) and/or the like.

The network 6 may include a collection of various different nodes, devices or functions that may be in communication with each other via corresponding wired and/or wireless interfaces. For example, the network may include one or more base stations, such as one or more node Bs, evolved node Bs (eNBs), access points, relay nodes or the like, each of which may serve a coverage area divided into one or more cells. For example, the network may include one or more cells, including, for example, the RNC 2, each of which may serve a respective coverage area. The serving cell could be, for example, part of one or more cellular or mobile networks or public land mobile networks (PLMNs). In turn, other devices such as processing devices (e.g., personal computers, server computers or the like) may be coupled to the mobile terminal and/or other communication devices via the network.

The mobile terminal 8 may be in communication with each other or other devices via the network 6. In some cases, each of the mobile terminals may include an antenna or antennas for transmitting signals to and for receiving signals from a base station. In some example embodiments, the mobile terminal 8, also known as a client device, may be a mobile communication device such as, for example, a mobile telephone, portable digital assistant (PDA), pager, laptop computer, tablet computer, or any of numerous other hand held or portable communication devices, computation devices, content generation devices, content consumption devices, universal serial bus (USB) dongles, data cards or combinations thereof. As such, the mobile terminal 8 may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal 8 may also include communication circuitry and corresponding hardware/software to enable communication with other devices and/or the network 14.

Referring now to FIG. 1b, an apparatus 20 that may be embodied by or otherwise associated with a mobile terminal 8 (e.g., a cellular phone, a personal digital assistant (PDA), smartphone, notebook, tablet and laptop computers or the like) may include or otherwise be in communication with a processor 22, a memory device 24, a communication interface 28, a user interface 30, and a camera 32.

In some example embodiments, the processor 22 (and/or co-processors or any other processing circuitry assisting or otherwise associated with the processor) may be in communication with the memory device 24 via a bus for passing information among components of the apparatus 20. The memory device 24 may include, for example, one or more non-transitory volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device 24 could be configured to store instructions for execution by the processor 22.

The apparatus 20 may, in some embodiments, be embodied by a mobile terminal 8. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading. In the embodiment in which the apparatus 20 is embodied as a mobile terminal 10, the processor may be embodied by the processor of the mobile terminal.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal 8) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 28 may be any means such as a device or circuitry embodied in either hardware or a combination of hardware and software that is configured to receive and/or transmit data from/to a network and/or any other device or module in communication with the apparatus 20. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In order to support multiple active connections simultaneously, such as in conjunction with a digital super directional array (DSDA) device, the communications interface of one embodiment may include a plurality of cellular radios, such as a plurality of radio front ends and a plurality of base band chains. In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some example embodiments, such as instances in which the apparatus 20 is embodied by a mobile terminal 8, the apparatus may include a user interface 30 that may, in turn, be in communication with the processor 22 to receive an indication of a user input and/or to cause provision of an audible, visual, mechanical or other output to the user. As such, the user interface may include, for example, a keyboard, a mouse, a joystick, a display, a touch screen(s), touch areas, soft keys, a microphone, a speaker, or other input/output mechanisms. Alternatively or additionally, the processor may comprise user interface circuitry configured to control at least some functions of one or more user interface elements such as, for example, a speaker, ringer, microphone, display, and/or the like. The processor and/or user interface circuitry comprising the processor may be configured to control one or more functions of one or more user interface elements through computer program instructions (e.g., software and/or firmware) stored on a memory accessible to the processor (e.g., memory device and/or the like).

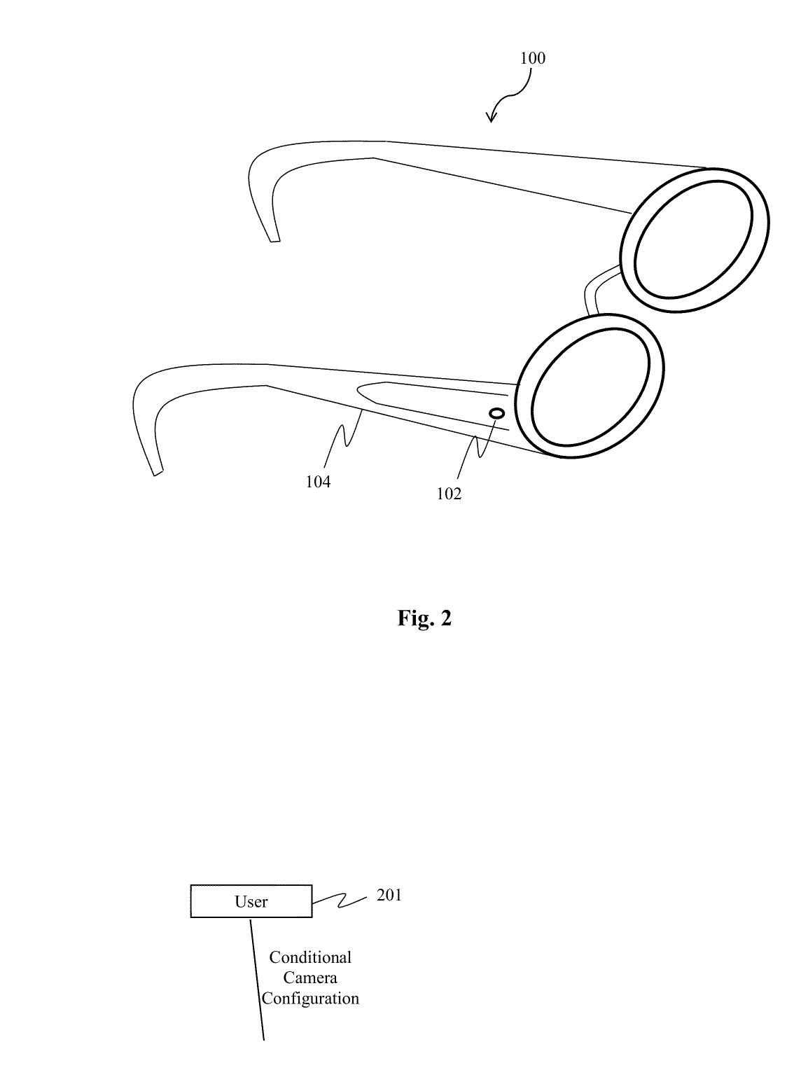

The camera 32 may be a miniature video camera such as those commonly installed in mobile terminals 8 (e.g., cell phones, notebook, tablet and laptop computers, PDA's, etc.). The camera 32 may also be a standard miniature video camera with an associated microphone (not shown). It may also be a fixed remote audio/video device located in a conference room, an auditorium, a classroom, an office, a home, or other public or private place. The camera may have communication capability through the processor 22 and communications interface 28 with a wireless network or it may be wired to a local area network within a facility. The camera might also take a form similar to that shown in FIG. 2.

An example embodiment of a remote multimedia recording equipment platform 100 is illustrated in FIG. 2. Eyeglasses can be adapted to carry a miniature video camera 102. The camera 102 can be embedded in a small compartment built into the temple 104 of the glasses frame. The associated microphone (not shown) can be carried in the same or the other temple of the glasses. The wearer of the glasses 100 simply looks at a scene and, when the video camera 102 is activated by the recording interface, the scene's sights and sounds can be recorded and communicated, such as wirelessly, to a data storage memory, or can be streamed to another user, or can be uploaded to a designated IP or other address for viewing or storage.

A software application such as a calendar function may serve as an embodiment of an interface that can be configured to cause a remote recording platform to be activated for recording a scene, an event, or a person. A calendar function within a software application, such as Microsoft Outlook® application, has the capability to record dates and times of future events and present a user with notification that an event is due to occur. In an example embodiment, the calendar function, running on a mobile terminal for instance, can be augmented with a wireless network communications capability by which the calendar function can send a triggering signal to the remote recording platform to begin recording. The length of the recording session can be set in the calendar entry for the event and communicated to the remote platform. Similarly, the calendar function could send a termination signal when recording can stop.

It is not necessary for the “calendar” application to be a commercial software application. It merely has to be a software module that is capable of setting and storing dates, times, and durations for future events, and sending triggering signals when those events are set to occur and end, to be applicable to the several embodiments described herein. Such a module should also be able to append data such as configuration settings to communications that it sends to media devices. Either the calendar module, or a control software module using the calendar module as an interface, should also be capable of receiving messages wherein the media devices accept or reject configuration settings and requests.

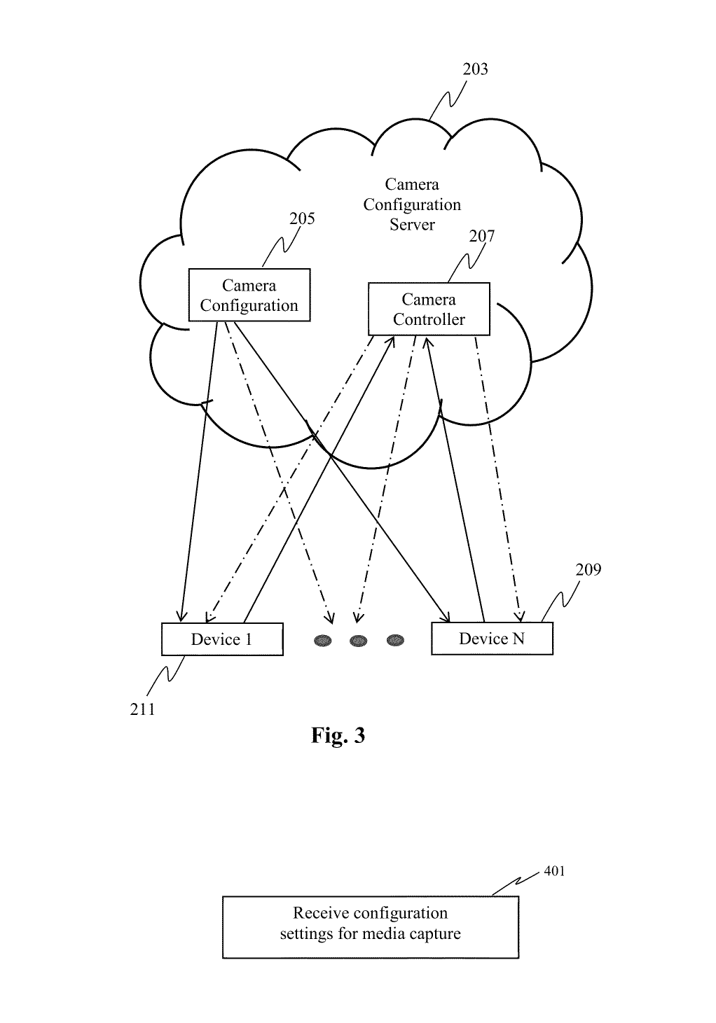

Referring to FIG. 3, there is illustrated one example embodiment of a remote audio/video (A/V) configuration/control arrangement. Many arrangements are possible within the scope of the invention. At either end of the arrangement are the user 201 and the A/V devices 209, 211. Between them may be a form of wireless network 203 or a local area network (LAN) (such as in a large facility) or other type of networked command/control system. In general, the user 201 enters configuration information (time, place, event, target, etc.) locally and sends it to a configuration server 203. A configuration server 203 may be a device (like a network server) or a virtual location that can be addressed for communication of targeted command/control information. The user 201 generates a configuration for an A/V capture she would like to make and sends it to the Camera Configuration Server 203. The user's configuration settings are communicated 205 to the remote device 209 or devices 209, 211 (if more than one), setting them to operate as intended. The Camera Controller 207 functions as director, receiving reports of the activation of the devices 209, 211 when their configuration settings are activated.

The Camera Controller 207 also receives condition reports from the individual cameras and uses them to activate other cameras when necessary. For instance, if camera A is blocked from a desired scene it reports that information to the Controller 207, which can immediately configure another camera to record the desired scene. The Camera Controller 207 also acts as the receiver of streaming data from the cameras for storage and/or distribution when that is necessary.

For example, a user 201 is at home, and is planning for an event. In a calendar application, he configures the time of the meeting. This determines the time at which the capture will start taking place. He can add the name of the people who have to be recorded. For instance, if Stephen Jones is in the view of a camera, then only record him. A list of names can be provided in the calendar settings for recording individuals. All of these factors comprise Conditional Configuration for the camera in that the actuation of the camera is conditioned or is dependent upon one or more factors. The camera controller 207 controls the several cameras 209, 211. The configuration can be conditional. That is, if the camera configuration requires recording video of Pranav and camera A is not capturing Pranav (that is, he is not visible to camera A), then camera B can record Pranav provided he is in its field of view.

In another example, perhaps the user 201 configures the cameras to record a cricket match through Pranav's camera. However, at the necessary time for some reason Pranav is not looking at the match. The camera controller can switch to camera B and start the video capture using that camera, which is trained on the scene to be recorded.

The audio and visual cues once received by the device through some settings (through Outlook® or the like), can be analyzed by the device. For example, a setting may establish image capture only if A is recognized. In this case, a camera analyzes each frame (or a sample frame every second) for faces present in the scene. And when one of the faces is recognized to be A, then the device does a capture. Multiple cameras can be used to analyze the scene present in front of them. And there may be cameras towards the back, facing the camera (user's) eyes. These cameras are used to analyze the gaze of the user. Also, there could be a microphone sensor, which can be used to analyze the audio sound and control the camera accordingly. Alternatively, it can be objects which have to be recorded. For example, a setting may define that if the user is in front of a painting, the recording should start. That can be configured in the calendar settings. These are examples of visual cues.

Alternatively, the user can add the speakers at which the recording has to take place. These are audio cues. For example, a setting may establish that audio is to be recorded only if Stephen Jones is speaking Other audio cues like “only when music is playing” are also possible. Or, record when the user himself starts speaking

The user can also specify other colleagues/devices that will help in the recording. For example, the user can add his wife's recording device to help. If she accepts, her device will do the recording according to the calendar settings sent by the user. This is useful, if there are multiple events, which one person alone cannot cover. If friends or relatives are in the same event and there are many sub events within the same event, then based on location, phonebook or social data, the server interface could broadcast requests with the user's contacts for their recording to start if their calendar doesn't have the event updated. Once they see the message and accept it, recording can start and when event is finished the user will get an automatic trigger with location of an uploaded media location where the user can view the recordings or take best of recorded recordings.

Each of these parameters can be incorporated into the camera configuration that is sent to the camera configuration server 203. The camera configuration 205 is input to the camera controller 207. The camera controller 207 communicates directly with each camera or other multimedia recording device 209, 211, programming each device to operate according to the user's needs expressed in the camera configuration 205.

The server can also configure still cameras. For example, user 201 takes a photograph, perhaps in a concert. But there are human obstacles in between, and the image does not contain the entire scene (as desired by the user). The camera of this embodiment sends the configuration parameter, like the location of the camera and the direction in which the camera has taken the image, to the camera configuration server 203. The camera controller 207 may then direct the cameras in the vicinity, facing the direction of the scene, to capture images. Later, the server may collate the several images and provide a user interface (UI) for the user 201 to go deeper into the scene. The UI could be something like: User clicks an obstacle in the image. And the view which opens up is an image taken from the perspective of that obstacle in an instance in which the obstacle has an associated camera that also captured an image. Also, the UI may highlight the obstacles from where the images have been taken (for example, by showing a red dot. It is not necessary, that all the obstacles have cameras on them.)

Added features can enhance the utility of example embodiments of the invention. The user could specify an IP or other address to where the recording of the media will be posted and at what interval they should be posted. The camera configuration server 203 may serve as the conduit for the data transmission to the specified address.

The calendar setting can be sent to the camera configuration server 203 specifying the needs of the user with a request for assistance. The server 203 may send messages to several potential assistants requesting aid. Other users participating in the event can accept or reject the request for assistance. If the request is accepted, the primary user 201 will get all the images/video specified by his settings, taken by the person who has accepted the request. The settings could also be transferred to other users in the event by near field communications (NFC) or other sharing technologies.

For example, using the calendar, perhaps the user is inviting A, B and C. The user wants them to capture images, if B is with Pranav. In the calendar setting, it can be done as below:

| A | B | C |
|---|---|---|
| Capture when B is with | | Capture when B is with |
| Pranav | | Pranav |

User may specify these conditions and they are automatically configured for all other users.

When A gets the invitation, he also gets the message “Capture when B is with Pranav. (Accept/Reject)”. If A accepts, the setting is received by the camera configuration server. And camera controller forms the necessary cloud of cameras to share information between them.

In another example, using the calendar, perhaps the user is inviting A, B and C. And the user wants them to capture images, if any of them notices, Pranav blowing out a candle.

| A | B | C |
|---|---|---|
| Capture if A, B, C | Capture if A, B, C notice | Capture if A, B, C |
| notice Pranav blowing | Pranav blowing the | notice Pranav blowing |
| the candle | candle | the candle |

If A, B, and C accept, the camera configuration server 203 will note these settings. If any of the devices notifies the server that Pranav is blowing out the candle, such as a result of having performed image recognition on the captured images, it notifies the other devices as well, and they start their capture.

A user can also configure the settings for capture based upon his emotions. He can set the settings to start capture when the user is happy. Or, the setting could be to capture when the user claps, such as determined by an audio analysis of signals received by a microphone.

Capture could be set to start if the user has fallen asleep. For example, if user is watching a cricket match and has fallen asleep, the glasses 100 can measure the blink level of user's eyes and start the recording automatically when the blink level is determined to reach a predefined threshold, such as by being less than a predetermined value. If something interesting happens, and perhaps the audience claps and user wakes up, he can see the recording. Alternatively, it can be streamed to him from another user based upon the settings specified in the interface. Or the recording can be controlled by simple gestures. Intervention in a configured session is useful when the event could have been delayed after the recorder reaches the venue but the calendar could not be updated as there was no prior information on the delay.

Another useful feature may be to start capture if the user is not looking at a scene, as determined by an analysis of an image captured by a camera carried by eyeglasses worn by the user. For example, user is in a badminton match, and turns away to chat with someone. The recording can be streamed from other users to the user at that instant.

The user can do normal recording as well. But these settings help him to pre-plan the event. Also, he can enjoy the event more, and forget the recording part as this happens automatically.

The above settings can be easily seen to be helpful in media recording. If the user wants to speak in his own voice (e,g, his opinions about the speaker) or wants to twitter his own message, he could do so in a parallel channel. For example he could write down his opinion in a paper and the text or his audio alone can be transmitted as one parallel stream. During that time, the video streaming can be switched to a configuration specified in the calendar interface.

Viewer can switch to a mode, where the video will be automatically refocused to where the capturer is gazing. For example, if the user is looking at George Smith, the video will be refocused, for the viewer, at George Smith. This can be done using light-field cameras. Viewer can either use this mode, or choose to focus on someone else. To achieve this, the gaze of the user is stored as metadata in the video.

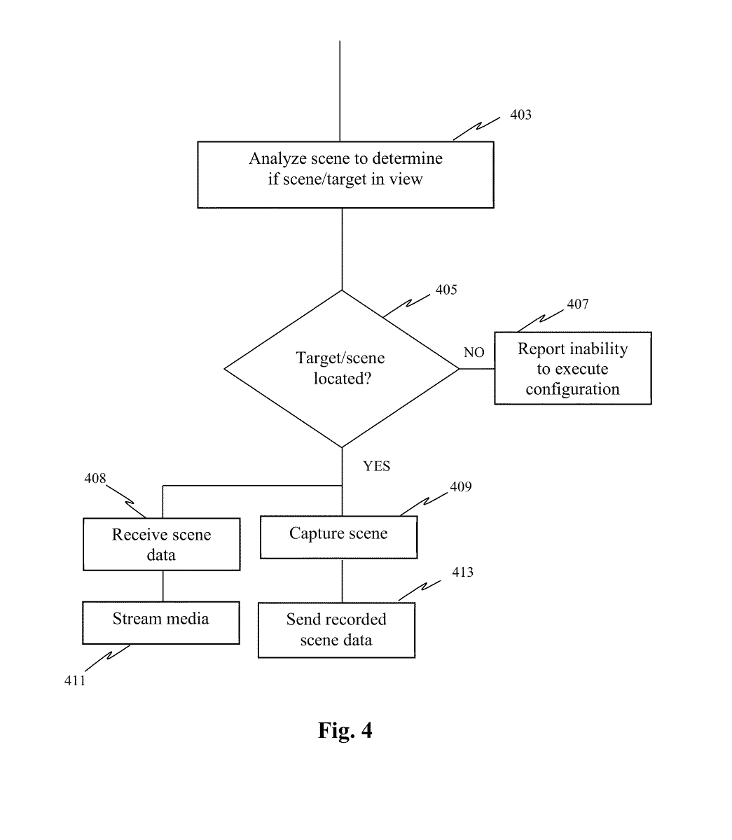

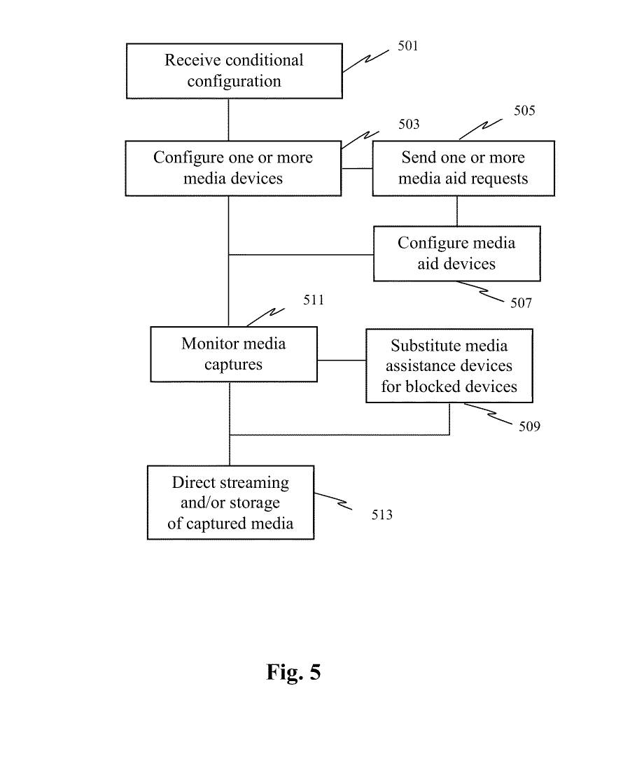

Various functions of the embodiments are illustrated in FIGS. 4 and 5. In FIG. 4, an apparatus 20 embodied by a media device may include means, such as the processor 22, the communications interface 28 or the like, for receiving configuration settings 401 for capturing audio/video information, referred to generally as a “scene.” The scene may be a meeting, a game, a speech, a person or group of persons, or an inanimate target (that is, a thing). The configuration may specify recording audio only, video only, a combination of the two, or the capture of still images (photos). The apparatus embodied by the media device may also include means, such as the processor or the like, for, once a configuration is received, analyzing the target scene at 403 to determine if the scene target (that is, person, thing, game, etc.) is in view of the media device. If the target scene is located and in view, the apparatus embodied by the media device may include means, such as the processor or the like, for receiving the recorded scene data that has been captured according to the configuration settings and means, such as the processor, the communications interface or the like, for causing the recorded scene data to be sent to data storage. See block 413. As shown in blocks 409 and 411, the apparatus embodied by the media device may also include means, such as the camera or the like, for capturing the scene and means, such as the processor, the communications interface or the like, for causing the recorded scene data to be streamed 408, 411 to the user.

FIG. 5 illustrates the functions of an embodiment of a configuration server. In this regard, an apparatus 20 of the type generally shown in FIG. 1b may be embodied by the configuration server, albeit generally without a camera 32 and, in some instances, without a user interface 30. The apparatus embodied by the configuration server may include means, such as the processor 22, the communications interface 28 or the like, for receiving conditional configuration settings 501 from a user. Through its control function the apparatus embodied by the configuration server may include means, such as the processor, the communications interface or the like, for configuring one or more media capture devices 503 in accordance with the conditional configuration settings, such as by causing configuration settings to be provided to the one or more media capture devices. The apparatus embodied by the server may deem it necessary or advisable to send requests to extra media devices for aid 505 in capturing the media events for which the user has conditionally provided setting information and, as such, may include means, such as the processor, the communications interface or the like, for causing one or more requests to other media devices for assistance in capturing the media events. If the requested media devices agree to aid the capture as signaled, for example, by the requested media devices in a reply message, the apparatus embodied by the server may include means, such as the processor, the communications interface or the like, for configuring 507 the additional media devices, such as by causing configuration settings to be provided to the one or more additional media devices. While media capture proceeds at the media devices, the apparatus embodied by the server may include means, such as the processor, the communications interface or the like, for monitoring the media capture activity 511. If any of the media capture devices are blocked from their target(s) or otherwise to capture the desired image, the apparatus embodied by the server may include means, such as the processor, the communications interface or the like, for substituting available assistance media devices 509 so that the scene may be captured as requested. In this regard, the apparatus embodied by the server may be configured to cause signals to be transmitted to the other media devices to request assistance of the media devices in capturing the desired images. Either during capture or after it is completed, the apparatus embodied by the server may include means, such as the processor, the communications interface, the memory 24 or the like, for directing the streaming or the storage of the captured media data 513.

As described above, FIGS. 4-5 are flowcharts of a method, apparatus and program product according to example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by a processor 22 in the apparatus. As will be appreciated, any such computer program instructions may be loaded onto a computer or other programmable apparatus (e.g., hardware) to produce a machine, such that the resulting computer or other programmable apparatus embody a mechanism for implementing the functions specified in the flowchart blocks. These computer program instructions may also be stored in a non-transitory computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 4-5, when executed, convert a computer or processing circuitry into a particular machine configured to perform an example embodiment of the present invention. Accordingly, the operations of FIGS. 4-5 define an algorithm for configuring a computer or processing circuitry (e.g., processor) to perform an example embodiment. In some cases, a general purpose computer may be configured to perform the functions shown in FIGS. 4-5 (e.g., via configuration of the processor), thereby transforming the general purpose computer into a particular machine configured to perform an example embodiment.

Accordingly, blocks of the flowcharts support combinations of means for performing the specified functions, combinations of operations for performing the specified functions and program instructions for performing the specified functions. It will also be understood that one or more blocks of the flowcharts, and combinations of blocks in the flowcharts, can be implemented by special purpose hardware-based computer systems which perform the specified functions or operations, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
receiving conditional configuration data including scene target for media capture;
configuring one or more camera devices;
monitoring media captured by the one or more configured devices; and
directing streamed output or storage of captured media data.

2. The method of claim 1, further comprising:
causing one or more requests for assistance to accomplish media capture to be sent; and
configuring one or more assisting camera devices to accomplish media capture.

3. The method of claim 1 further comprising:
starting a scene capture based on a biofeedback indicator.

4. The method of claim 3 wherein the biofeedback indicators include at least one of: happiness, anger, sight focus, a handclap, a gesture, closed eyes, and speech patterns.

5. The method of claim 1 further comprising:
receiving the conditional configuration from a calendar software application, wherein a signal to begin media capture originates in the calendar software application, and wherein a signal to terminate media capture originates in the calendar software application.

6. The method of claim 1 further comprising:
actuating one or more secondary cameras to record a target scene when the primary camera is unable to record the target scene.

7. The method of claim 1 further comprising:
conditioning audio/video capture on the presence of a specified individual in a scene.

8. The method of claim 1 further comprising:
conditioning audio/video capture on the occurrence of a specified event.

9. An apparatus comprising at least a processor, a memory associated with the processor, and computer coded instructions stored in the memory, the instructions, when executed by the processor, cause the apparatus to:
receive conditional configuration data including scene target for media capture;
configure one or more camera devices;
monitor media captures by the one or more configured devices; and
direct streamed output or storage of captured media data.

10. The apparatus of claim 9, wherein the apparatus is further caused to:
send one or more requests for assistance to accomplish media capture;
configure one or more assisting camera devices to accomplish media capture.

11. The apparatus of claim 9, wherein the apparatus is further caused to:
start a scene capture based on a biofeedback indicator.

12. The apparatus of claim 11, wherein the biofeedback indicators include at least one of: happiness, anger, sight focus, a handclap, a gesture, closed eyes, and speech patterns.

13. The apparatus of claim 9, wherein the apparatus is further caused to:
receive the conditional configuration from a calendar software application, wherein a signal to begin media capture originates in the calendar software application, wherein a signal to terminate media capture originates in the calendar software application.

14. The apparatus of claim 9, wherein the apparatus is further caused to:
actuate one or more secondary cameras to record a target scene when the primary camera is unable to record the target scene.

15. The apparatus of claim 9, wherein the apparatus is further caused to:
condition audio/video capture on the presence of a specified individual in a scene.

16. The apparatus of claim 9, the apparatus is further caused to:
condition audio/video capture on the occurrence of a specified event.

17. A computer program product comprising a computer readable medium having coded computer instructions stored therein, said instructions when executed by a processor causing a device to perform:
receiving conditional configuration data including scene target for media capture;
configuring one or more camera devices;
monitoring media captures by the one or more configured devices; and
directing streamed output or storage of captured media data.

18. The computer program product of claim 17 wherein the instructions further cause a device to perform:
causing one or more requests for assistance to accomplish media capture to be sent; and
configuring one or more assisting camera devices to accomplish media capture.

19. The computer program product of claim 17 wherein the instructions further cause a device to perform:
starting a scene capture based on a biofeedback indicator.

20. The computer program product of claim 19 wherein the biofeedback indicators include at least one of: happiness, anger, sight focus, a handclap, a gesture, closed eyes, and speech patterns.
